(19) United States
(12) Patent Application Publication
(10) Pub. No.: US 2014/0255555 A1
(43) Pub. Date: Sep. 11, 2014

(54) Solid Food with Surface Coating Layer and Automatic Process and Equipment for Making the Solid Food

(71) Applicant: Chin-Shih Chen, Taichung City (TW)

(72) Inventor: Chin-Shih Chen, Taichung City (TW)

(21) Appl. No.: 13/789,979

(22) Filed: Mar. 8, 2013

(51) Int. Cl. A23G 3/54

(52) U.S. Cl. CPC A23G 3/54
USPC 426/93; 426/89; 426/297; 118/20

(57) ABSTRACT

An automatic process includes dissolving a sticky coating layer, pouring the sticky coating layer onto a main material, bonding a covering layer onto the sticky coating layer to form a semi-product of a solid food, cooling the semi-product to cool the sticky coating layer, and vibrating the semi-product to drop an overlapping part of the covering layer so as to form a solid food which includes the main material, the sticky coating layer and the covering layer. Thus, the solid food is made in an automated manner to save the working time, to reduce the cost of production, and to increase the working efficiency. In addition, the solid food is made automatically so that the product of the solid food satisfies the standardized requirement, thereby enhancing the quality of production.

### BACKGROUND OF THE INVENTION

1. Field of the Invention

The present invention relates to a solid food, such as a cake and the like, and, more particularly, to a solid food with a surface coating layer and an automatic process and equipment for making the solid food.

2. Description of the Related Art

A conventional cake comprises a cake body, a chocolate enclosed around the surface of the cake body, and multiple almond particles bonded onto the chocolate. In fabrication, the substances of the cake body are initially pressed and baked to form the cake body. Then, the chocolate is dissolved and poured onto the surface of the cake body. Then, the almond particles are attached to the chocolate. Then, the chocolate is dried and cured to secure the almond particles to the cake body. However, the cake is made in a manual manner so that the process for making the cake takes mush time and manual energy, thereby increasing the cost of fabrication, and thereby decreasing the working efficiency. In addition, the cake is made manually so that the operator directly touches the substances for making the cake during the manufacturing process, thereby easily causing a sanitary problem.

### BRIEF SUMMARY OF THE INVENTION

The primary objective of the present invention is to provide an automatic process and equipment for making a solid food with a main material (such as a cake), a sticky coating layer (such as a chocolate), and a covering layer (such as almond particles).

In accordance with one embodiment of the present invention, there is provided a solid food, comprising a main material, a sticky coating layer encompassing an outer surface of the main material, and a covering layer mounted on the sticky coating layer and attached to the main material by a sticky feature of the sticky coating layer.

In accordance with another embodiment of the present invention, there is provided an automatic process for making a solid food, comprising a first step of drying a covering layer, a second step of dissolving a sticky coating layer, a third step of pouring the sticky coating layer onto a main material, a fourth step of bonding the covering layer onto the sticky coating layer to attach the covering layer to the main material so as to form a semi-product of a solid food, a fifth step of cooling the semi-product of the solid food to cool the sticky coating layer, a sixth step of vibrating the semi-product of the solid food to drop an overlapping part of the covering layer so as to form a product of the solid food which comprises the main material, the sticky coating layer and the covering layer, and a seventh step of packaging the solid food.

In accordance with another embodiment of the present invention, there is provided an automatic equipment for making a solid food, comprising a first conveyor device, a dissolving tank, a pouring device, an air blasting device, an attachment device, a second conveyor device, a cooling device, a vibration device, and a gathering device. The first conveyor device delivers a main material to the pouring device. The dissolving tank contains a sticky coating layer. The sticky coating layer is dissolved in the dissolving tank to form a viscous and sticky liquid. The pouring device includes a rotation member connected to the dissolving tank, and a container connected to the rotation member. The container of the pouring device is located above the first conveyor device and the main material. The container of the pouring device has a bottom provided with a pouring hole aligning with the main material. The rotation member of the pouring device is rotated to convey the sticky coating layer in the dissolving tank into the container of the pouring device. The sticky coating layer in the container of the pouring device is drained outward from the pouring hole of the container and is poured onto a surface of the main material to form a combination of the main material and the sticky coating layer. The air blasting device blows the combination of the main material and the sticky coating layer to dry the sticky coating layer. The attachment device contains a covering layer. The attachment device includes at least one agitator and a motor connected with the agitator to drive the agitator. The combination of the main material and the sticky coating layer is delivered by the first conveyor device into the attachment device to mix with the covering layer. The agitator is rotated by the motor to stir and blend the covering layer with the combination of the main material and the sticky coating layer, so that the covering layer is attached to the sticky coating layer so as to form a semi-product of a solid food. The semi-product of the solid food in the attachment device is delivered by the second conveyor device to the cooling device. The cooling device is located above the second conveyor device. The semi-product of the solid food on the second conveyor device is cooled by the cooling device. The vibration device is located at an end terminal of the second conveyor device. The vibration device includes a support plate connected to the second conveyor device to support the semi-product of the solid food, and a vibrator connected with the support plate to vibrate the support plate. The support plate is driven by the vibrator to vibrate the semi-product of the solid food and to drop an overlapping part of the covering layer so as to form a product of the solid food which comprises the main material, the sticky coating layer and the covering layer. The gathering device is connected to the vibration device to gather and package the solid food.

According to the primary advantage of the present invention, the solid food is made in an automated manner so that the solid food can be produced largely to save the working time and energy, to reduce the cost of production, and to increase the working efficiency.

According to another advantage of the present invention, the solid food is made automatically so that the product of the solid food satisfies the standardized requirement, thereby enhancing the quality of production.

According to a further advantage of the present invention, the solid food is made automatically so that the solid food will not be touched by any person during the manufacturing process, thereby preventing the solid food from incurring a sanitary problem.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a solid food in accordance with the preferred embodiment of the present invention.

FIG. 2 is a side cross-sectional view of the solid food as shown in FIG. 1.

FIG. 3 is a perspective view of a solid food in accordance with another preferred embodiment of the present invention.

FIG. 4 is a side cross-sectional view of the solid food as shown in FIG. 3.

FIG. 5 is a flow chart of an automatic process for making a solid food in accordance with the preferred embodiment of the present invention.

FIG. 6 is a front cross-sectional view of an automatic equipment for making a solid food in accordance with the preferred embodiment of the present invention.

FIG. 7 is a locally enlarged operational view of the automatic equipment for making a solid food as shown in FIG. 6.

FIG. 8 is a locally enlarged operational view of the automatic equipment for making a solid food as shown in FIG. 6.

FIG. 9 is a top view of the automatic equipment for making a solid food as shown in FIG. 8.

FIG. 10 is a locally enlarged operational view of the automatic equipment for making a solid food as shown in FIG. 6.

FIG. 11 is a locally enlarged operational view of the automatic equipment for making a solid food as shown in FIG. 6.

FIG. 12 is a perspective view of a solid food in accordance with another preferred embodiment of the present invention.

FIG. 13 is a perspective view of a solid food in accordance with another preferred embodiment of the present invention.

FIG. 14 is a perspective view of a solid food in accordance with another preferred embodiment of the present invention.

### DETAILED DESCRIPTION OF THE INVENTION

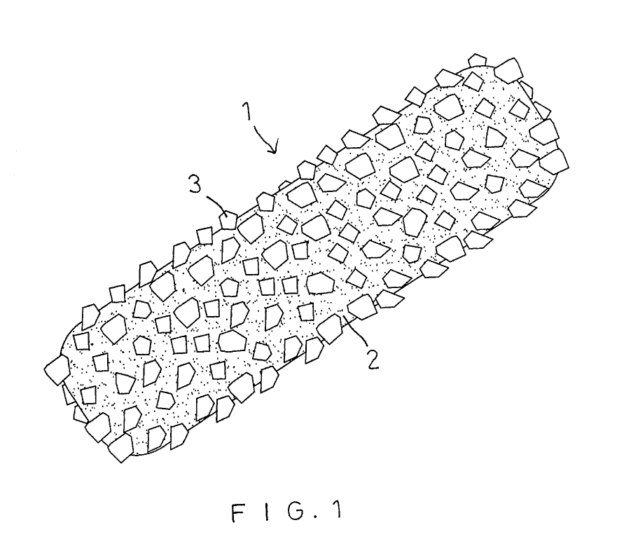

Referring to the drawings and initially to FIGS. 1-4, a solid food 1 in accordance with the preferred embodiment of the present invention comprises a main material 11, a sticky coating layer 2 encompassing an outer surface of the main material 11, and a covering layer 3 mounted on the sticky coating layer 2 and attached to the main material 11 by a sticky feature of the sticky coating layer 2.

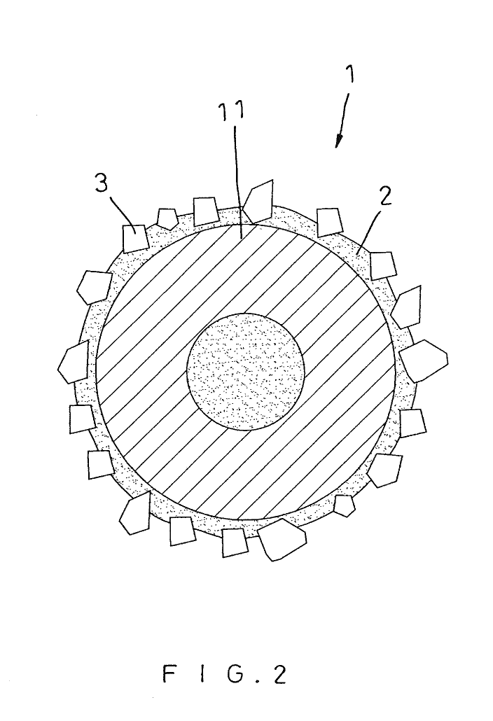

As shown in FIGS. 1 and 2, the main material 11 of the solid food 1 is a cake which has a substantially cylindrical cross-sectional profile.

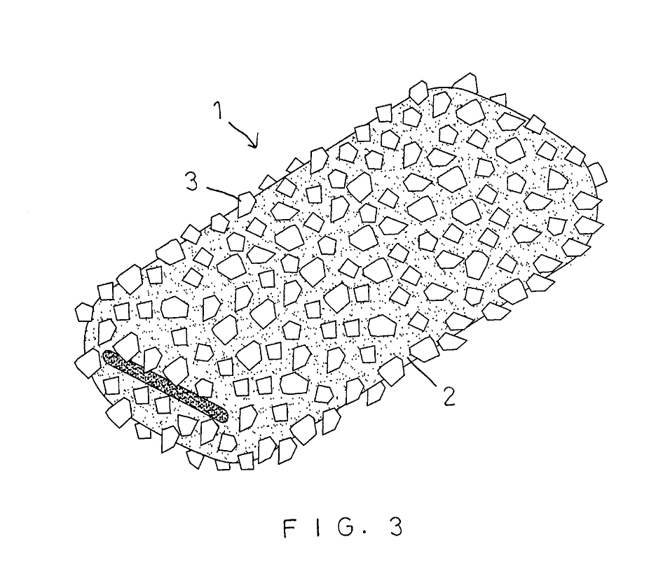

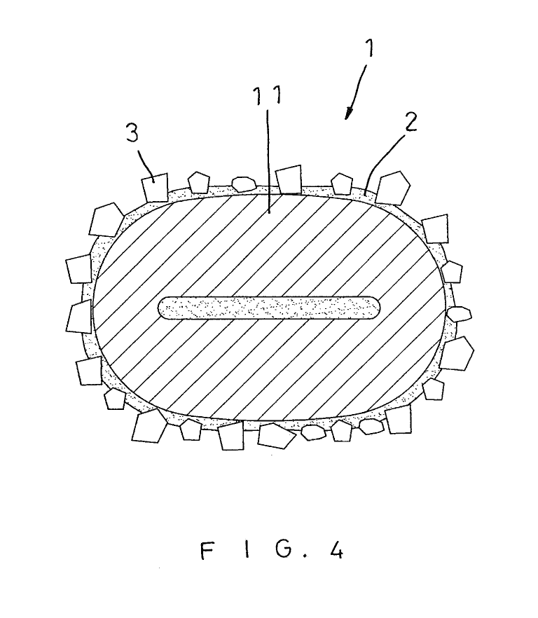

As shown in FIGS. 3 and 4, the main material 11 of the solid food 1 is a cake which has a substantially oblong cross-sectional profile.

In the preferred embodiment of the present invention, the main material 11 consists of multiple mixed substances including corn, rice, unpolished rice, yolk powder, granulated sugar, salt, palm oil, soy sauce powder, and malt powder. The soy sauce powder consists of multiple mixed elements including soybean, wheat, salt and sugar. The multiple mixed substances of the main material 11 are pressed and baked to form the main material 11. The sticky coating layer 2 includes chocolate or malt sugar. The covering layer 3 includes almond particles or earthnut particles.

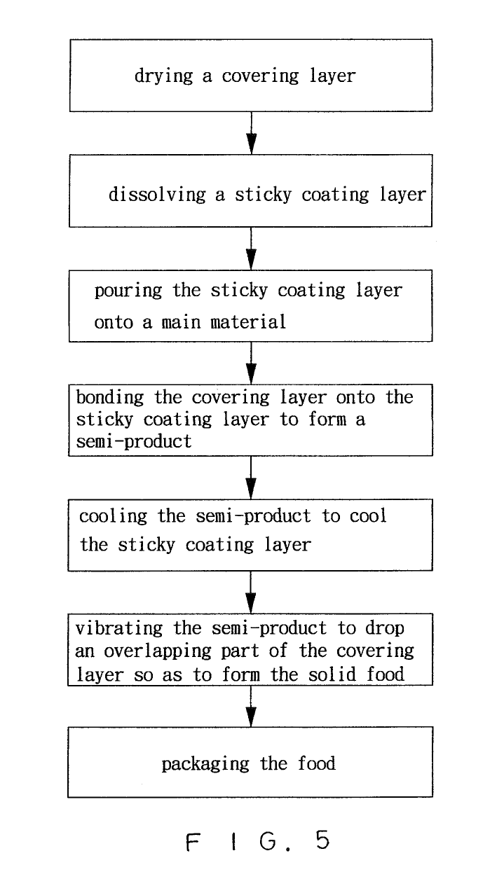

Referring to FIG. 5 with reference to FIGS. 1 and 2, an automatic process for making a solid food 1 in accordance with the preferred embodiment of the present invention comprises a first step of drying a covering layer 3 (such as almond particles), a second step of dissolving a sticky coating layer 2 (such as a chocolate), a third step of pouring the sticky coating layer 2 onto a main material 11 (such as a cake), a fourth step of bonding the covering layer 3 onto the sticky coating layer 2 to attach the covering layer 3 to the main material 11 so as to form a semi-product of a solid food 1, a fifth step of cooling the semi-product of the solid food 1 to cool the sticky coating layer 2, a sixth step of vibrating the semi-product of the solid food 1 to drop an overlapping part of the covering layer 3 so as to form a product of the solid food 1 which comprises the main material 11, the sticky coating layer 2 and the covering layer 3, and a seventh step of packaging the solid food 1. In the first step, the covering layer 3 is dried at the temperature of about 170° C. In the third step, the sticky coating layer 2 is poured onto the main material 11 at the temperature of about 39° C. In the fifth step, the sticky coating layer 2 is cooled at the temperature of about 14° C.

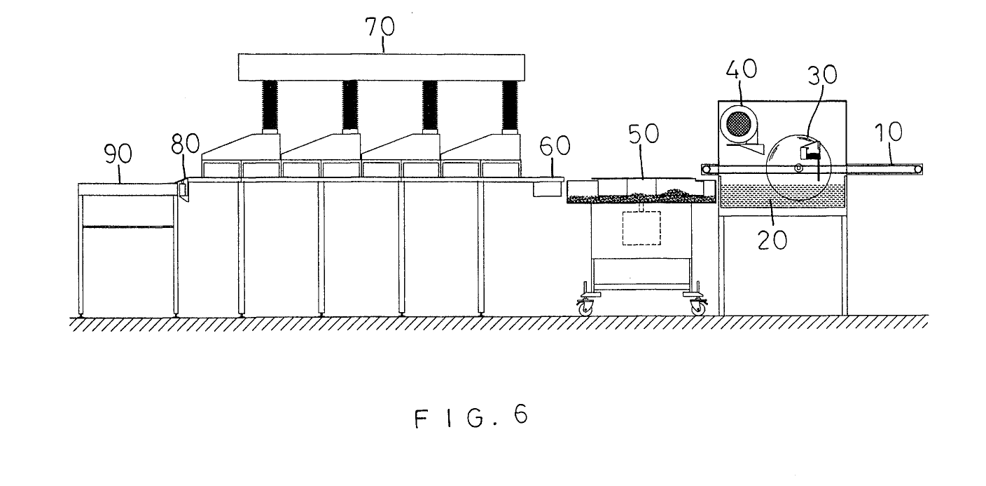

Referring to FIGS. 6-11 with reference to FIGS. 1 and 2, an automatic equipment for making a solid food 1 in accordance with the preferred embodiment of the present invention comprises a first conveyor device 10, a dissolving tank 20, a pouring device 30, an air blasting device 40, an attachment device 50, a second conveyor device 60, a cooling device 70, a vibration device 80, and a gathering device 90.

The first conveyor device 10 extends through the dissolving tank 20, the pouring device 30 and the air blasting device 40. The first conveyor device 10 delivers a main material 11 to the pouring device 30.

The dissolving tank 20 contains a sticky coating layer 2. The sticky coating layer 2 is dissolved in the dissolving tank 20 to form a viscous and sticky liquid.

The pouring device 30 is located above the dissolving tank 20. The pouring device 30 includes a rotation member 31 connected to the dissolving tank 20, and a container 32 connected to the rotation member 31. The container 32 of the pouring device 30 is located above the first conveyor device 10 and the main material 11. The container 32 of the pouring device 30 has a bottom provided with a pouring hole 33 aligning with the main material 11. The rotation member 31 of the pouring device 30 is rotated to convey the sticky coating layer 2 in the dissolving tank 20 into the container 32 of the pouring device 30. The sticky coating layer 2 in the container 32 of the pouring device 30 is drained outward from the pouring hole 33 of the container 32 as shown in FIG. 7 and is poured onto a surface of the main material 11 evenly and smoothly to form a combination of the main material 11 and the sticky coating layer 2.

The air blasting device 40 is located above the first conveyor device 10 and the main material 11. The air blasting device 40 blows the combination of the main material 11 and the sticky coating layer 2 to dry the sticky coating layer 2.

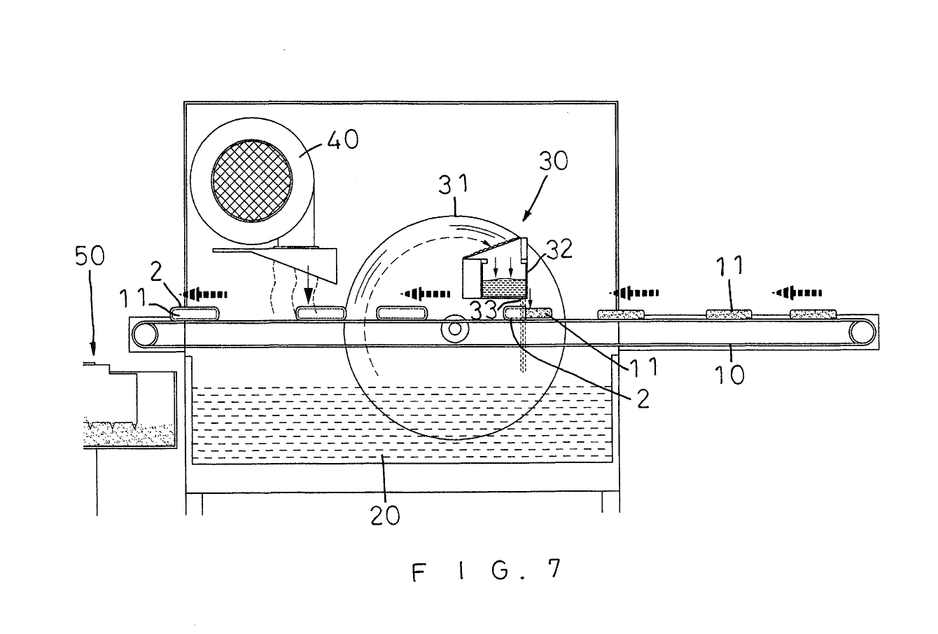

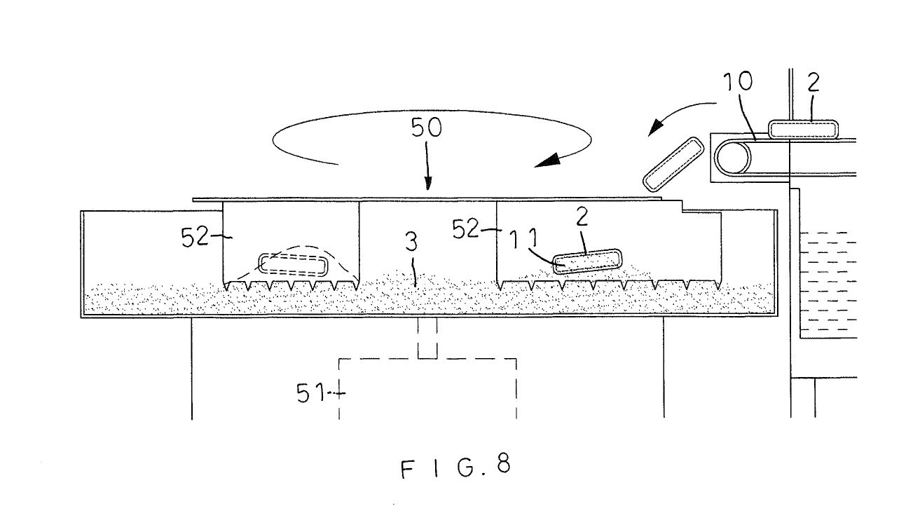

The attachment device 50 is connected to and located under the first conveyor device 10. The attachment device 50 contains a covering layer 3. The attachment device 50 includes at least one agitator 52 and a motor 51 connected with the agitator 52 to drive the agitator 52. The combination of the main material 11 and the sticky coating layer 2 is delivered by the first conveyor device 10 into the attachment device 50 to mix with the covering layer 3. The agitator 52 is rotated by the motor 51 to stir and blend the covering layer 3 with the combination of the main material 11 and the sticky coating layer 2 as shown in FIGS. 8 and 9, so that the covering layer 3 is attached to the sticky coating layer 2 evenly so as to form a semi-product of a solid food 1.

The second conveyor device 60 is connected to the attachment device 50 and is extended through the cooling device 70 and the vibration device 80. The semi-product of the solid food 1 in the attachment device 50 is delivered by the second conveyor device 60 to the cooling device 70.

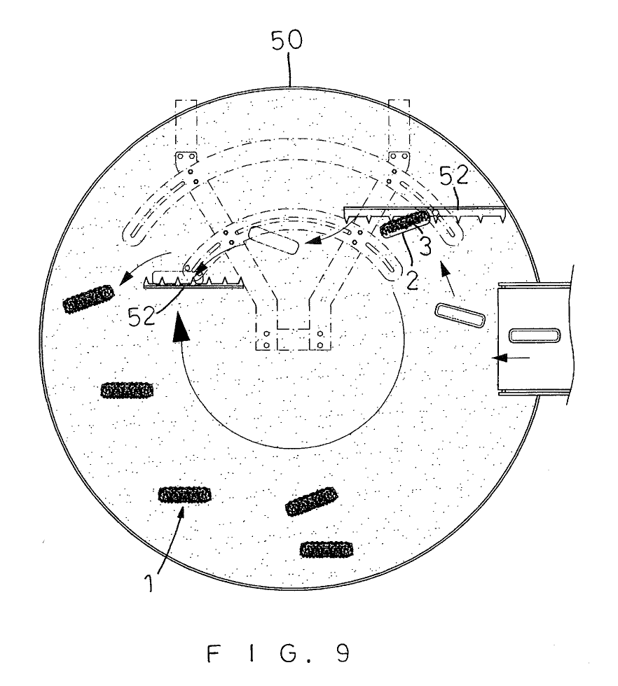

The cooling device 70 is located above the second conveyor device 60. The semi-product of the solid food 1 on the second conveyor device 60 is cooled by the cooling device 70 as shown in FIG. 10.

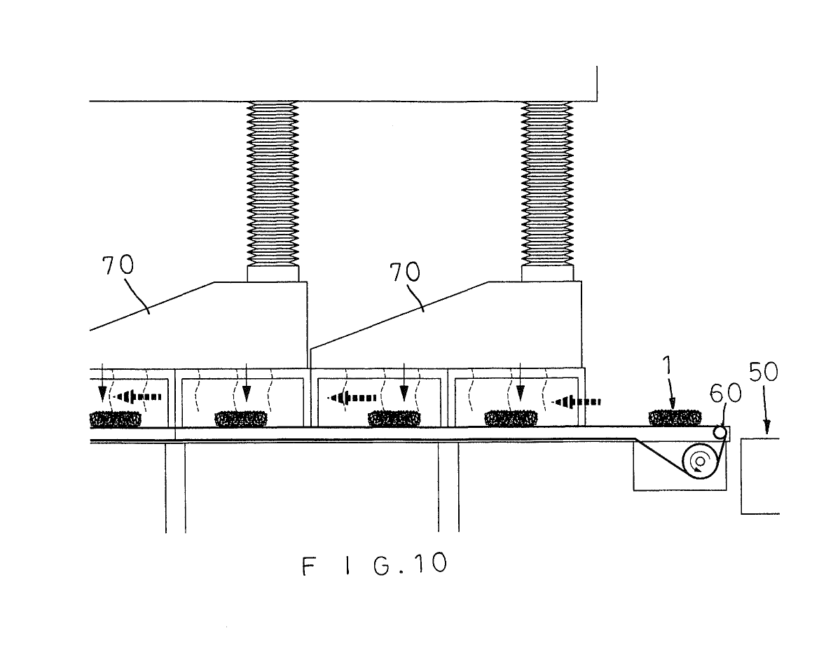

The vibration device 80 is located at an end terminal of the second conveyor device 60. The vibration device 80 includes a support plate 82 connected to the second conveyor device 60 to support the semi-product of the solid food 1, and a vibrator 81 connected with the support plate 82 to vibrate the support plate 82. The support plate 82 is driven by the vibrator 81 to vibrate the semi-product of the solid food 1 and to drop an overlapping part of the covering layer 3 as shown in FIG. 11 so as to form a product of the solid food 1 which comprises the main material 11, the sticky coating layer 2 and the covering layer 3.

The gathering device 90 is connected to the vibration device 80 to gather and package the solid food 1.

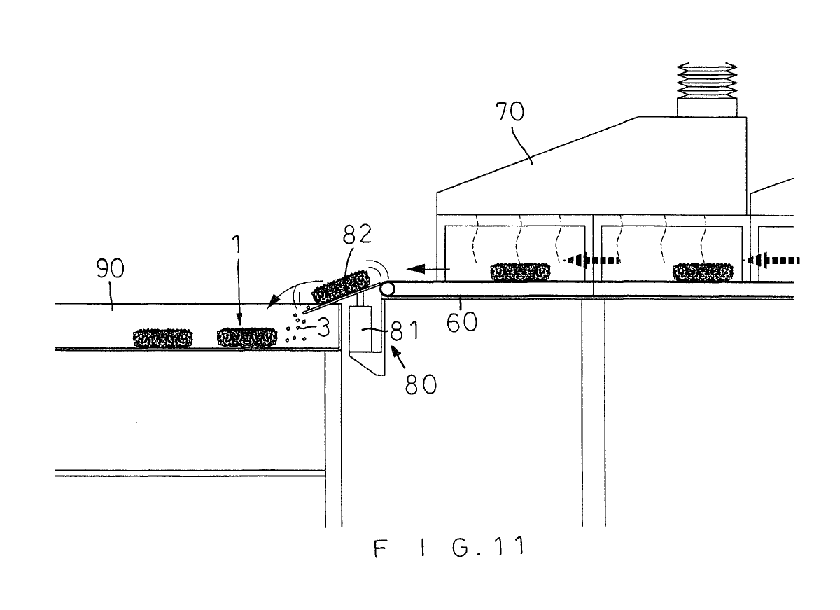

As shown in FIG. 12, the solid food 1 a has a strip shape.

As shown in FIG. 13, the solid food 1 b has a spherical shape.

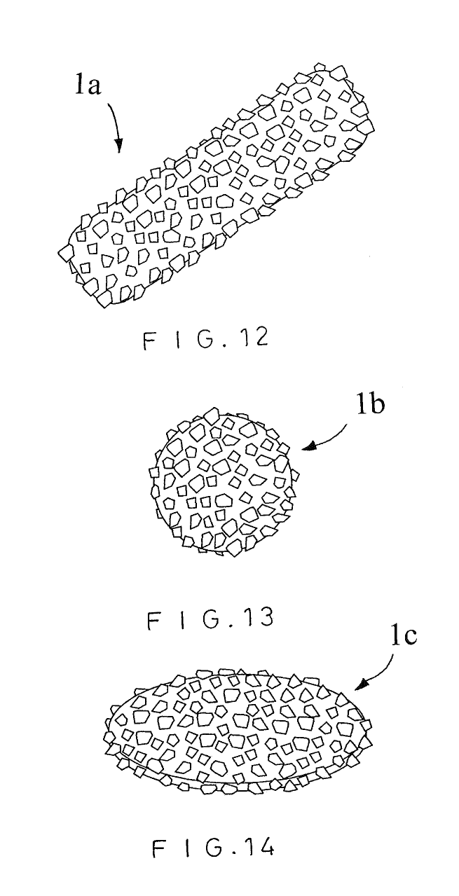

As shown in FIG. 14, the solid food 1 a has an oblong shape.

Accordingly, the solid food 1 is made in an automated manner so that the solid food 1 can be produced largely to save the working time and energy, to reduce the cost of production, and to increase the working efficiency. In addition, the solid food 1 is made automatically so that the product of the solid food 1 satisfies the standardized requirement, thereby enhancing the quality of production. Further, the solid food 1 is made automatically so that the solid food 1 will not be touched by any person during the manufacturing process, thereby preventing the solid food 1 from incurring a sanitary problem.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A solid food, comprising:
a main material;
a sticky coating layer encompassing an outer surface of the main material; and
a covering layer mounted on the sticky coating layer and attached to the main material by a sticky feature of the sticky coating layer.

2. The solid food of claim 1, wherein the main material of the solid food has a substantially cylindrical cross-sectional profile.

3. The solid food of claim 1, wherein the main material of the solid food has a substantially oblong cross-sectional profile.

4. The solid food of claim 1, wherein the main material consists of multiple mixed substances including corn, rice, unpolished rice, yolk powder, granulated sugar, salt, palm oil, soy sauce powder, and malt powder.

5. The solid food of claim 1, wherein the sticky coating layer includes chocolate.

6. The solid food of claim 1, wherein the sticky coating layer includes malt sugar.

7. The solid food of claim 1, wherein the covering layer includes almond particles.

8. The solid food of claim 1, wherein the covering layer includes earthnut particles.

9. The solid food of claim 4, wherein the soy sauce powder consists of multiple mixed elements including soybean, wheat, salt and sugar.

10. An automatic process for making a solid food, comprising:
a first step of drying a covering layer;
a second step of dissolving a sticky coating layer;
a third step of pouring the sticky coating layer onto a main material;
a fourth step of bonding the covering layer onto the sticky coating layer to attach the covering layer to the main material so as to form a semi-product of a solid food;
a fifth step of cooling the semi-product of the solid food to cool the sticky coating layer;
a sixth step of vibrating the semi-product of the solid food to drop an overlapping part of the covering layer so as to form a product of the solid food which comprises the main material, the sticky coating layer and the covering layer; and
a seventh step of packaging the solid food.

11. The automatic process for making a solid food of claim 10, wherein the solid food has a strip shape.

12. The automatic process for making a solid food of claim 10, wherein the solid food has a spherical shape.

13. The automatic process for making a solid food of claim 10, wherein the solid food has an oblong shape.

14. An automatic equipment for making a solid food, comprising:
a first conveyor device, a dissolving tank, a pouring device, an air blasting device, an attachment device, a second conveyor device, a cooling device, a vibration device, and a gathering device; wherein:
the first conveyor device delivers a main material to the pouring device;
the dissolving tank contains a sticky coating layer;
the sticky coating layer is dissolved in the dissolving tank to form a viscous and sticky liquid;
the pouring device:
includes a rotation member connected to the dissolving tank; and
a container connected to the rotation member;
the container of the pouring device is located above the first conveyor device and the main material;
the container of the pouring device has a bottom provided with a pouring hole aligning with the main material;
the rotation member of the pouring device is rotated to convey the sticky coating layer in the dissolving tank into the container of the pouring device;
the sticky coating layer in the container of the pouring device is drained outward from the pouring hole of the container and is poured onto a surface of the main material to form a combination of the main material and the sticky coating layer;
the air blasting device blows the combination of the main material and the sticky coating layer to dry the sticky coating layer;
the attachment device contains a covering layer;
the attachment device includes:
at least one agitator; and
a motor connected with the agitator to drive the agitator;
the combination of the main material and the sticky coating layer is delivered by the first conveyor device into the attachment device to mix with the covering layer;
the agitator is rotated by the motor to stir and blend the covering layer with the combination of the main material and the sticky coating layer, so that the covering layer is attached to the sticky coating layer so as to form a semi-product of a solid food;
the semi-product of the solid food in the attachment device is delivered by the second conveyor device to the cooling device;
the cooling device is located above the second conveyor device;
the semi-product of the solid food on the second conveyor device is cooled by the cooling device;
the vibration device is located at an end terminal of the second conveyor device;
the vibration device includes:
a support plate connected to the second conveyor device to support the semi-product of the solid food; and
a vibrator connected with the support plate to vibrate the support plate;
the support plate is driven by the vibrator to vibrate the semi-product of the solid food and to drop an overlapping part of the covering layer so as to form a product of the solid food which comprises the main material, the sticky coating layer and the covering layer; and
the gathering device is connected to the vibration device to gather and package the solid food.

15. The automatic equipment for making a solid food of claim 14, wherein the main material is a cake, the sticky coating layer includes chocolate, and the covering layer includes almond particles.

16. The automatic equipment for making a solid food of claim 14, wherein the solid food has a strip shape.

17. The automatic equipment for making a solid food of claim 14, wherein the solid food has a spherical shape.

18. The automatic equipment for making a solid food of claim 14, wherein the solid food has an oblong shape.

19. The automatic equipment for making a solid food of claim 14, wherein:
the first conveyor device extends through the dissolving tank, the pouring device and the air blasting device;
the pouring device is located above the dissolving tank;
the air blasting device is located above the first conveyor device and the main material;
the attachment device is connected to and located under the first conveyor device; and
the second conveyor device is connected to the attachment device and is extended through the cooling device and the vibration device.
